(19) United States
(12) Patent Application Publication
(10) Pub. No.: US 2017/0164422 A1
(43) Pub. Date: Jun. 8, 2017

(54) METHODS IN WIRELESS BODY AREA NETWORKS AND A HUB FOR A WIRELESS BODY AREA NETWORK

(71) Applicant: KABUSHIKI KAISHA TOSHIBA, Tokyo (JP)

(72) Inventor: Siva Kupanna Subramani, Bristol (GB)

(21) Appl. No.: 15/124,931

(22) PCT Filed: Aug. 28, 2014
(86) PCT No.: PCT/GB2014/052611

§ 371 Date: Sep. 9, 2016

(51) Int. Cl. H04W 84/18; H04L 29/08; H04W 28/10; H04B 1/7097; H04W 16/14

(52) U.S. Cl. CPC H04W 84/18; H04B 1/7097; H04W 16/14; H04W 28/10; H04L 29/08396; H04B 2001/7152

(57) ABSTRACT

According to one embodiment is a method in a hub of a first wireless body area network (WBAN). The first WBAN includes the hub and at least one sensor node. The hub is configured to wirelessly communicate with the at least one sensor node on a first frequency channel and the method comprises: receiving a retention index of a second WBAN operating on the first frequency channel, wherein a retention index is a measure of the operational characteristics of the respective WBAN; comparing the retention index of the second WBAN with a retention index of the first WBAN; and changing the wireless communication behaviour of the first WBAN if the retention index of the first WBAN is lower than the retention index of the second WBAN.

### FIELD

Embodiments described herein relate generally to coexistence coordination in wireless body area networks.

### BACKGROUND

Wireless body area networks (WBANs) are used for monitoring, logging and transmitting vital healthcare signals. WBANs generally comprise a hub and one or multiple sensor nodes, often in the form of on-body devices which may monitor and transmit data to the hub. WBANs are normally low powered devices and have a transmission range of only a few meters—sufficient for the on-body devices to communicate with the hub.

As WBANs are generally disposed about a wearer's person, they can be considered to be randomly distributed and mobile. As people move around, WBANs are likely to move into the transmission range of other WBANs, resulting in interference. This is especially the case in areas densely populated with such devices, for example crowded areas and, in particular, hospitals. Interference can become a problem, especially when it leads to the loss or inefficient transmission of life-critical information—this may be the case in hospitals. It therefore becomes important that WBANs are able to coexist, especially as their use becomes more prevalent.

### BRIEF DESCRIPTION OF THE DRAWINGS

FIG. 1A schematically illustrates two WBANs with a coexistence coordination mechanism;

FIG. 1B illustrates the WBANs and associated on-body devices of FIG. 1A;

FIG. 2 illustrates a flow diagram for a retention-based coexistence coordination method according to an embodiment;

FIG. 3 illustrates an embodiment of the initiate coordination process of FIG. 2;

FIG. 4A illustrates an embodiment of the exchange retention index (RI) value process of FIG. 2 when RI1>R12;

FIG. 4B illustrates an embodiment of the exchange retention index (RI) value process of FIG. 2 when RI1<RI2;

FIG. 5 is a graph of sample RI values as calculated by an example definition;

FIG. 6 is a graph of sample RI values as calculated by an alternative example definition;

FIG. 7 illustrates an exemplar MAC superframe structure considered in an embodiment;

FIG. 8 illustrates an example of two interfering MAC superframes before coexistence coordination;

FIG. 9 illustrates an example of two previously-interfering MAC superframes after coexistence coordination according to an embodiment.

FIG. 10 schematically illustrates a sensor node;

FIG. 11 schematically illustrates a hub in accordance with an embodiment; and

FIG. 12 illustrates a flow diagram for a single WBAN for a retention-based coexistence coordination method according to an embodiment.

### DETAILED DESCRIPTION

According to one embodiment is a method in a hub of a first wireless body area network (WBAN), the first WBAN comprising the hub and at least one sensor node, the hub being configured to wirelessly communicate with the at least one sensor node on a first frequency channel, the method comprising: receiving a retention index of a second WBAN operating on the first frequency channel, wherein a retention index is a measure of the operational characteristics of the respective WBAN; comparing the retention index of the second WBAN with a retention index of the first WBAN; and changing the wireless communication behaviour of the first WBAN if the retention index of the first WBAN is lower than the retention index of the second WBAN.

Embodiments described herein establish a clear set of coordination mechanisms to be used in resolving coexistence among potentially interfering WBANs. The present disclosure does this through proposing a method by which it can be determined which WBAN retains its wireless communication behaviour (e.g. access period) and which WBAN changes its wireless communication behaviour (e.g. access period). The present embodiments provide a simple, unambiguous and efficient coexistence mechanism. The embodiments are simple because only one WBAN changes its wireless behaviour. The embodiments are unambiguous because unambiguous communication message sequences are laid out that establish which WBAN is to change its wireless behaviour.

An embodiment may be for use with wireless network coexistence coordination between a first wireless body area network (WBAN) and a second WBAN, and the method may comprise: comparing a retention index of the first WBAN and a retention index of the second WBAN; and choosing at least one of the first and second WBAN to change its wireless communication behaviour based upon the comparison.

An embodiment may be used on a plurality of pairs of WBANs operating on a single frequency channel. As such, an embodiment may be used iteratively to enable coexistence between more than two WBANs on a single frequency channel.

An embodiment may be suitable for use with wireless network coexistence coordination. An embodiment may undertake wireless network coexistence coordination.

An embodiment may further comprise: initiating communication between the first and second WBAN; calculating retention indices for each WBAN; and sending the retention index from at least one of the first and second WBAN to the other of the first and second WBAN.

A WBAN may comprise a hub and a number of sensor nodes which may be in the form of on-body devices. The sensor nodes may measure certain characteristics of their environment/the patient and then communicate with the hub, which coordinates the WBAN. This communication may be done wirelessly. This wireless communication may be done using a superframe protocol. The remote sensor nodes may generally comprise on-body devices and so this term will frequently be used herein; however, it is to be understood that the present disclosure is not limited to use with sensor nodes located on a user's body. The term sensor node can be used to describe any part of the WBAN that communicates with the hub. A sensor node may be physically connected to a hub e.g. a hub may have an inbuilt sensor.

Each on-body device is generally located on a user's body, although as stated above, this may not always be the case. A sensor node may comprise a sensor or monitor not located on a user, perhaps measuring an environmental variable. Examples of on-body devices include, but are not limited to heart rate monitors, thermometers, respiratory monitors and biochemical sensors. The on-body devices may comprise any sensor measuring an attribute of the user or the environment.

WBANs compatible with the present embodiments may comprise any number of sensor nodes e.g. on-body devices. WBANs suitable for use with the present methods may comprise one, two, three, four, five or more than five sensor nodes e.g. on-body devices. WBANs may comprise more than 10, 15 or 20 sensor nodes e.g. on-body devices.

The hub will generally coordinate and control the sensor nodes. As such, methods described herein will generally be carried out on the hub of a WBAN. As such, where it is said that a WBAN undertakes a certain method, it may be understood that the hub of the respective WBAN is undertaking the method. The communication within a WBAN is coordinated by the hub.

With regard to the method by which a WBAN handles wireless communication between the hub and the sensor node(s), a WBAN may divide the time axis into periodical frames—“superframes”. Each superframe may be bounded by beacon slots, or beacon periods. The beacon periods may contain information regarding the WBAN and its transmission characteristics. The superframe may comprise an active period, during which time the WBAN is active (e.g. the hub and node(s) are transmitting and/or receiving) and an inactive period, during which time the WBAN is not active.

The embodiments may be for use with two WBANs operating on the same frequency channel which are liable to, or are, experiencing interference. The interfering WBANs may wirelessly communicate according to a periodic superframe structure. Interference may occur when a first WBAN enters the transmission range of a second WBAN or rather, a sensor node of a first WBAN enters the transmission range of the hub of a second WBAN (or vice versa). Interference may result in a loss of data or a reduction in the efficacy of a WBAN. As such, it may be desirable in this situation for one of the WBANs to change its wireless communication behaviour to reduce or eliminate the interference.

In order to decrease the complexity and increase the efficiency of such methods, it may be desirable that only one of the two interfering WBANs changes its wireless communication behaviour, to avoid a complicated system which may be liable to perform inefficiently. An object of the methods disclosed herein is to reduce the complexity—and hence inefficiency—of coexistence methods. Scheduling and synchronisation complexities are minimised by the described methods. The approaches disclosed herein simplify the coexistence process for the WBAN that maintains its wireless communication behaviour and hence simplifies the coexistence process as a whole.

It is often beneficial to have the WBAN for which the repercussions of lost or inefficient data transfer are greater maintain its wireless communication behaviour and the other WBAN, for which data transfer inefficiency may be less likely to have serious ramifications, change its wireless communication behaviour. An embodiment may facilitate the selection of the WBAN that should change its wireless communication behaviour.

In an embodiment, each WBAN has an associated retention index (RI). The retention index may be calculated as part of the method, or may be pre-calculated and/or saved within the hub of the respective WBAN. In the present disclosure, the terms retention index and RI value are used interchangeably.

The RI value may reflect the nature and specific characteristics of the participating WBANs. The RI value may reflect the operational characteristics of the respective WBAN. It is felt that characteristics of individual WBANs can be considered during coordination to make coordination more efficient. The RI value may reflect the priority of the corresponding WBAN. WBANs with a certain measure of operational characteristics may have more “right to stay” and may therefore be allowed to maintain their current wireless communication behaviour at the expense of another WBAN. A loss of information or transmission time for a WBAN with a higher RI value can potentially be more damaging than loss of information for a WBAN with a lower RI value. A WBAN with a higher RI value may, therefore, be allowed to maintain its current wireless communication behaviour in the present embodiment. Thus embodiments provide an efficient solution to coexistence.

An embodiment may take into account all the pragmatic characteristics of a WBAN, applicable for intermittent and complex WBANs.

The RI value may be a user-definable index, the definition or calculation of which can be tailored to quantify the importance, or the “right-to-stay”, of WBANs. The RI value may reflect the potential risk associated with a loss of transmitted information.

The retention indices of any WBAN for which coexistence coordination is being undertaken may be compared. A choice as to which of the first and second WBAN is to change its wireless communication behaviour may be based upon the comparison of the RI values.

An embodiment may further comprise: calculating the retention index of the first WBAN.

Embodiments according to an embodiment may include each WBAN, or rather a hub thereof, calculating a RI.

Calculation of retention indices for each WBAN may occur before initiating communication between the first and second WBAN.

The retention indices may be calculated at any point before they are compared. Retention indices may not be calculated, but rather input as a non-variable characteristic of each, or a, WBAN which the hub of a WBAN is then able to read and compare with a hub of a further WBAN.

A retention index may be a function of at least one of N and \hat{D}, wherein N is the number of sensor nodes of the respective WBAN and \hat{D} is a measure of the duty cycle of the respective WBAN.

N may be the total number of sensor nodes. N may be the number of on-body devices. Other variables that may be used in place of N may be the number of sensor nodes of a certain type, or the number of sensor nodes deemed to be suitable for influencing the RI value. In other words, certain types of device or sensor node may be deemed irrelevant with regard to calculation of an RI value, i.e. the presence of a certain sensor node type may not be indicative of the risk associated with a potential loss of information by a certain WBAN.

The duty cycle may be the proportion of a cycle in which a signal is active.

\hat{D} may be the duty cycle normalised to a common superframe. This may be used when the period of activity is not the same for every superframe, in which case a useful value for the duty cycle can only be found by averaging out the activity over a number of superframes.

There may be a positive correlation between the value of the retention index and N.

There may be a positive correlation between the value of the retention index and \hat{D}.

As such, as the value of N and/or \hat{D} increases, the retention index value may increase.

The exact form of the correlation (e.g. linear, exponential, polynomial, logarithmic etc.) may be determined by the specifics of the situation, the location, the type and number of WBANs present, the WBAN area density. The user may determine the exact form of the correlation.

A retention index may be according to at least one of the following definitions:

RI=\hat{D}; (1)

RI=N; (2)

RI=(1+\hat{D})^{N}+k; or (3)

RI=(1+\hat{D})log N+k; (4)
wherein N is the number of sensor nodes of the respective WBAN, \hat{D} is a measure of the duty cycle of the respective WBAN and k denotes a constant proportional to performance drop.

Alternatively, the RI may be proportional to the above definitions, rather than equal to.

The performance drop may describe the reduction in received data. In an embodiment, the performance drop coefficient may represent the packet drop due to collision.

Each of the above definitions may be used in different situations in the present embodiment. Definition (1) may be used where the number of sensor nodes on the compared WBANs is the same. Definition (2) may be used when the normalised duty cycle of the compared WBANs is the same. Definitions (3) and (4) provide alternative methods of calculating the RI value when the number of sensor nodes on the compared WBANs is different and the normalised duty cycle of the compared WBANs is different.

The RI may be calculated according to the above definitions.

Whichever of the first and second WBAN has the lowest retention index may be chosen to change its wireless communication behaviour. The first WBAN may change its wireless communication behaviour if its RI is lower than that of the second WBAN.

If the compared RI values are the same, one of the WBANs may be chosen to change its wireless communication behaviour. The comparison of the RI values may comprise a function to determine whether a first RI value is greater than, or greater than or equal to, a second RI value. As such, whether the first WBAN changes its wireless behaviour or not when the RI values are same, depends on the specific comparison function chosen. It is very unlikely that two WBANs will have the same RI value in practice. If this occurs, an embodiment may switch to an alternative definition in which the WBANs do not have the same RI.

In some embodiments, the WBAN with the lowest retention index value may not change its wireless communication behaviour due to an extenuating circumstance. For example, the WBAN with the lowest RI value may comprise an emergency sensor node; such a sensor node may prevent the WBAN from changing its wireless communication behaviour. The WBAN with the lowest RI value may be monitoring a particularly at-risk patient; this may preclude the WBAN from changing its wireless communication behaviour. Alternatively, these extenuating circumstances may be taken into consideration in the RI value of the relevant WBAN.

As such, an embodiment may provide for the first WBAN, or the hub thereof, not to change its wireless communication behaviour, even if its RI value is lower than the RI value of the second WBAN.

A method in a hub of a WBAN may further comprise: sending a coordination request to a hub of the second WBAN; and receiving a coordination response from the hub of the second WBAN.

Communication may be initiated between the plurality of WBANs upon a first WBAN detecting a second WBAN, or a sensor node of a second WBAN, within the first WBAN's transmission range. Communication may be initiated by any of the WBANs.

Initiating communication between a first and second WBAN may comprise: one of the first and second WBANs sending a coordination request and the other of the first and second WBAN sending a coordination response.

A coordination response may comprise: an acceptance of coordination if the responding WBAN is not busy handling other coordination; or a busy response if the responding WBAN is handling other coordination.

In an embodiment as described herein, when the retention index of the first WBAN is greater than the retention index of the second WBAN, sending the retention index from at least one of the first and second WBAN to the other of the first and second WBAN and comparing the retention indices may comprise: the first WBAN sending its retention index to the second WBAN; the second WBAN comparing the retention index of the first WBAN to the retention index of the second WBAN; and the second WBAN sending an acknowledgement to the first WBAN.

The above method may provide a simple, direct and unambiguous chain of commands which facilitates clear communication and reduces complexity.

When the retention index of the second WBAN is greater than the retention index of the first WBAN, sending the retention index from at least one of the first and second WBAN to the other of the first and second WBAN and comparing the retention indices may comprise: the first WBAN sending its retention index to the second WBAN; the second WBAN comparing the retention index of the first WBAN to the retention index of the second WBAN; the second WBAN sending a non-acknowledgement to the first WBAN; the second WBAN sending its retention index to the first WBAN; the first WBAN comparing the retention index of the second WBAN to the retention index of the first WBAN; and the first WBAN sending an acknowledgement to the second WBAN.

The above method may provide a simple, direct and unambiguous chain of commands which facilitates clear communication and reduces complexity.

As such, whichever WBAN has the lowest RI value may receive the RI from the other WBAN and compare the RI values.

In some embodiments, both WBANs may send their RI to the other WBAN and may both receive the other WBAN's RI. Both WBANs may then compare the RI values.

An embodiment may further comprise: determining whether the first and second WBAN are suitable for coexistence. A first WBAN, or hub thereof, may determine whether the first and second WBANs are suitable for coexistence on a first frequency channel.

When the first and second WBAN wirelessly communicate according to a periodic superframe structure, determining whether the first and second WBAN are suitable for coexistence may comprise: assessing whether an inactive period of the superframe of the first WBAN is at least as long as an operating period of a superframe of the second WBAN; and assessing whether an inactive period of the superframe of the second WBAN is at least as long as an operating period of the superframe of the first WBAN; wherein the operating period comprises an active period of the respective WBAN.

A first WBAN and second WBAN may exchange information about their active and inactive periods over the first frequency channel.

An operating period of a first WBAN may describe a period of time during which the WBAN cannot, or should not, experience interference. An operating period of a first WBAN may, therefore, describe a period of time during which a second WBAN should not be active, so as to avoid affecting the wireless performance of the first WBAN.

An operating period may comprise the active period. The operating period of a first WBAN may comprise the active period of the first WBAN. The operating period of a first WBAN may consist of the active period of the first WBAN.

The operating period may comprise a beacon period of the respective WBAN. The operating period may comprise a beacon period to ensure that transmission of the beacon period does not experience any interference from nearby WBANs.

The operating period may comprise an offset period of the respective WBAN.

An offset period may be included as part of the operating period to act as a buffer, and to provide a margin of safety between the active periods of the two coexisting WBANs. The offset period may ensure that any slight deviations in the superframe period timing or the active period timing will not result in interference between WBANs. The offset period ensures that small time synchronisation issues don't cause a problem with interference.

The offset period may be user defined, or may be specified by a certain WBAN or frequency channel. The offset period may alternatively be negotiated between the WBANs (as described below).

Changing the wireless communication behaviour of a WBAN wirelessly communicating according to a superframe structure may comprise either: changing a parameter of the superframe of the WBAN (e.g. by adapting an active period of the superframe of the chosen WBAN) (i.e. that with the lowest RI) when the first and second WBAN are suitable for coexistence; or the chosen WBAN switching channel when the first and second WBAN are not suitable for coexistence.

When the first and second WBAN communicate wirelessly using a superframe structure and are suitable for coexistence, changing the wireless communication behaviour of the first WBAN may comprise: changing a parameter of the superframe of the first WBAN.

Changing a parameter of the superframe of the first WBAN may comprise: the active period of the superframe of the first WBAN being adapted so the operating period of the superframe of the first WBAN coincides with the inactive period of the superframe of the second WBAN and the operating period of the superframe of the second WBAN coincides with the inactive period of the superframe of the first WBAN.

Adapting the active period may refer to the start of the active period being shifted within the superframe, i.e. the beacon periods may remain unmodified, but the active period may shift within the superframe. Alternatively, the active period may be unchanged relative to the beacon periods, but the beacon periods may shift in the time domain, i.e. the whole superframe may shift in the time domain. A combination of the above types of adaptation may also be done. As such, adapting the active period may refer to adapting the active period relative to the superframe, adapting the active period relative to the time domain, or a combination of the two.

In some embodiments the active period may be lengthened or shortened. The superframe cannot be lengthened or shortened.

The active period may be adapted so that the operating period of the respective WBAN coincides with an inactive period of an interfering WBAN. In embodiments where the operating period comprises a beacon period and/or an offset period, the shifting of the active period relative to the beacon periods may ensure the operating period, including the beacon period and offset period, coincides with an inactive period of an interfering WBAN. This may occur when the beacon period of the first WBAN already coincides with the inactive period of the second WBAN.

Alternatively, when the beacon period of the first WBAN does not coincide with an inactive period of the second WBAN, the shifting of the active period may require the beacon periods (and hence the entire superframe) to shift within the time domain.

The WBAN with the lowest RI may adapt its wireless communication behaviour on the current frequency channel to allow coexistence. When the first WBAN has the lowest RI value and the first and second WBAN are suitable for coexistence, the hub of the first WBAN may change its wireless communication behaviour on the current frequency channel to allow coexistence.

This arrangement may allow the first and second WBANs to coexist on the same frequency channel without interference. In the above arrangement, only one of the first and second WBAN are active at a time. As such, the first and second WBAN may not be active at the same time, thus interference may be eliminated.

If coexistence is possible, the WBAN with the lower RI value sends clear information regarding its active period, offset period and/or the start and end of its inactive period in order to allow coexistence. The WBAN with the higher RI value may send clear information regarding its active period, offset period and/or the start and end of its inactive period. This exchanging of information may also occur after the wireless communication behaviour has been changed, in order to verify that it has been successfully done.

A feedback or iteration loop may be implemented to negotiate the offset period to ensure time synchronisation issues do not cause interference. The iteration loop may also verify the coordination is performed as agreed. The offset period may be negotiable between the WBANs to ensure small synchronisation issues do not cause interference. As such, the offset period may be negotiated during one or multiple iterations of the feedback loop, occurring after information regarding the WBANs' superframe, active and inactive periods has been exchanged.

When the first and second WBAN are not suitable for coexistence, changing the wireless communication behaviour of a WBAN, or of the first WBAN, may comprise: switching to a second frequency channel.

The WBAN with the lowest RI may switch frequency channel, to operate on another channel. When the first WBAN has the lowest RI value, the hub of the first WBAN may switch to a second frequency channel. This may be done when the superframe of the chosen WBAN is not suitable, or compatible, for coexistence with the, or an, other WBAN.

An embodiment may verify that the wireless communication behaviour has been successfully changed. An embodiment may comprise an iteration loop wherein a WBAN checks if the wireless communication behaviour has been changed and if coexistence has been achieved. As such, the iteration loop may verify that the coordination has been performed as agreed. This iteration loop may be undertaken by the first WBAN, the second WBAN, or both WBANs.

The first WBAN may check that the active period, inactive period and/or operating period are arranged such that interference is avoided. The first WBAN may check that the WBAN now communicates over a second frequency channel. The first WBAN may send the second WBAN information regarding its superframe, active period, inactive period and/or operating period and the second WBAN may check that the wireless communication behaviour has been successfully changed.

A further embodiment may be for rating the operational characteristics of two or more WBANs in order to ascertain which should be allowed to maintain their current wireless communication behaviour, the method comprising: comparing retention indices of each WBAN. The method may further comprise calculating retention indices for each WBAN.

A further embodiment may be in a hub of a first wireless body area network (WBAN), the first WBAN comprising the hub and at least one sensor node, and the method may comprise: wirelessly communicating with at least one sensor node of the first WBAN over a first frequency channel using a periodic superframe; receiving a result of a comparison between a retention index of a second WBAN operating on the first frequency channel and a retention index of the first WBAN, wherein a retention index is a measure of the operational characteristics of the respective WBAN; and changing the wireless communication behaviour of the first WBAN if the retention index of the first WBAN is lower than the retention index of the second WBAN.

The result may be received from the second WBAN.

A further embodiment is for determining whether a first and a second WBAN, are suitable for coexistence, the method comprising: assessing whether an inactive period of the superframe of the first WBAN is at least as long as an operating period of the superframe of the second WBAN; and assessing whether an inactive period of the superframe of the second WBAN is at least as long as an operating period of the superframe of the first WBAN; wherein the operating period comprises an active period of the respective WBAN.

According to a further embodiment is a hub for a wireless body area network (WBAN), the hub operable to wirelessly communicate with at least one sensor node over a first frequency channel and comprising: an antenna operable to receive a retention index of a further WBAN operating on the first frequency channel, wherein a retention index is a measure of the operational characteristics of the respective WBAN; and a processor operable to compare the retention index of the further WBAN with a retention index of the WBAN and change the wireless communication behaviour of the WBAN if the retention index of the WBAN is lower than the retention index of the further WBAN.

The hub and sensor nodes of the WBAN and further WBAN may communicate according to a periodic superframe structure. The WBAN and further WBAN may communicate according to a periodic superframe structure.

The retention index may be function of at least one of N and \hat{D}, wherein N is the number of sensor nodes of the respective WBAN and \hat{D} is a measure of the duty cycle of the respective WBAN.

The retention index may be according to at least one of the following definitions:

RI=\hat{D}; (1)

RI=N; (2)

RI=(1+\hat{D})^{N}+k; or (3)

RI=(1+\hat{D})log N+k; (4)
wherein k denotes a constant proportional to performance drop, N is the number of sensor nodes of the respective WBAN and \hat{D} is a measure of the duty cycle of the respective WBAN.

The processor may be configured, or may be operable, to calculate the retention index of the WBAN.

When the WBAN and further WBAN wirelessly communicate according to a periodic superframe structure, the processor may be configured, to or may be operable, to determine whether the WBAN and further WBAN are suitable for coexistence, by: assessing whether an inactive period of the superframe of the WBAN is at least as long as an operating period of a superframe of the further WBAN; and assessing whether an inactive period of the superframe of the further WBAN is at least as long as an operating period of the superframe of the WBAN; wherein the operating period comprises an active period of the respective wireless network.

The operating period may comprise one or more of: an active period, a beacon period and an offset period of the respective network.

When the WBAN and further WBAN wirelessly communicate according to a periodic superframe structure and the WBAN and further WBAN are suitable for coexistence, to change the wireless communication behaviour of the WBAN the processor may be configured, or be operable, to: change a parameter of the superframe of the WBAN.

To change a parameter of the superframe of the WBAN, the processor may be configured, or be operable, to: adapt the active period of the superframe of the WBAN so that the operating period of the superframe of the WBAN coincides with the inactive period of the superframe of the further WBAN and the operating period of the superframe of the further WBAN coincides with the inactive period of the superframe of the WBAN.

When the WBAN and further WBAN wirelessly communicate according to a periodic superframe structure and the WBAN and further WBAN are not suitable for coexistence, to change the wireless communication behaviour of the WBAN the processor may be configured, or be operable, to: switch to a second frequency channel.

According to a further embodiment is a computer readable carrier medium carrying computer executable instructions which, when executed on a processor, cause the processor to carry out a method as described herein.

According to a further embodiment is a wireless body area network apparatus configured to carry out any of the methods described herein.

Discussion of a feature in relation to any embodiment disclosed herein applies, mutatis mutandis to analogous features in any other embodiment of the present disclosure.

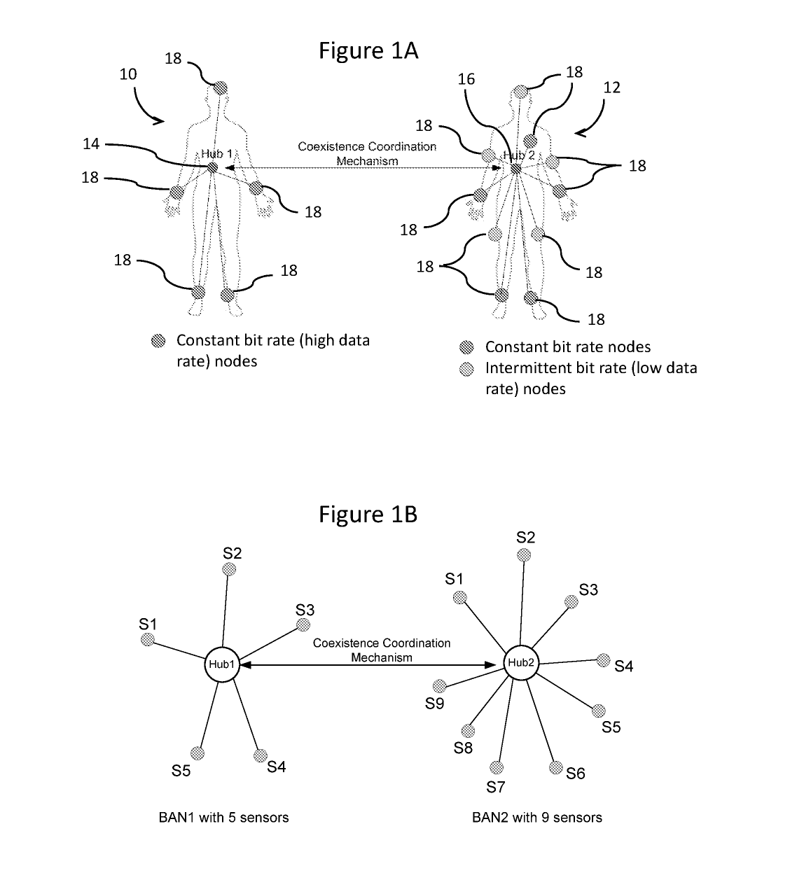

FIGS. 1A and 1B schematically illustrate two wireless body area networks (VVBANs) 10, 12. A WBAN may be designed for monitoring, logging and transmitting vital healthcare signals. In FIG. 1A, a first WBAN 10 is located on a first person, and a second WBAN 12 is located on a second person. Each WBAN comprises a hub 14, 16 and one or more on-body devices 18. An on-body device 18 is a type of sensor node. Each on-body device 18 transmits to the hub/coordinator 14, 16. An on-body device may have a constant bit rate, and therefore high data rate, or an intermittent bit rate, and therefore a low data rate. Each on-body device 18 is generally located on a user's body and may comprise, for example, a heart rate monitor, temperature sensor, respiratory sensor or a biochemical on-body device. It can be seen that a WBAN may often be considered for modelling purposes as a human body. In FIG. 1B, each on-body device is labelled S1-Sx; the first WBAN 12 comprises 5 on-body devices and the second WBAN 14 comprises 9 on-body devices.

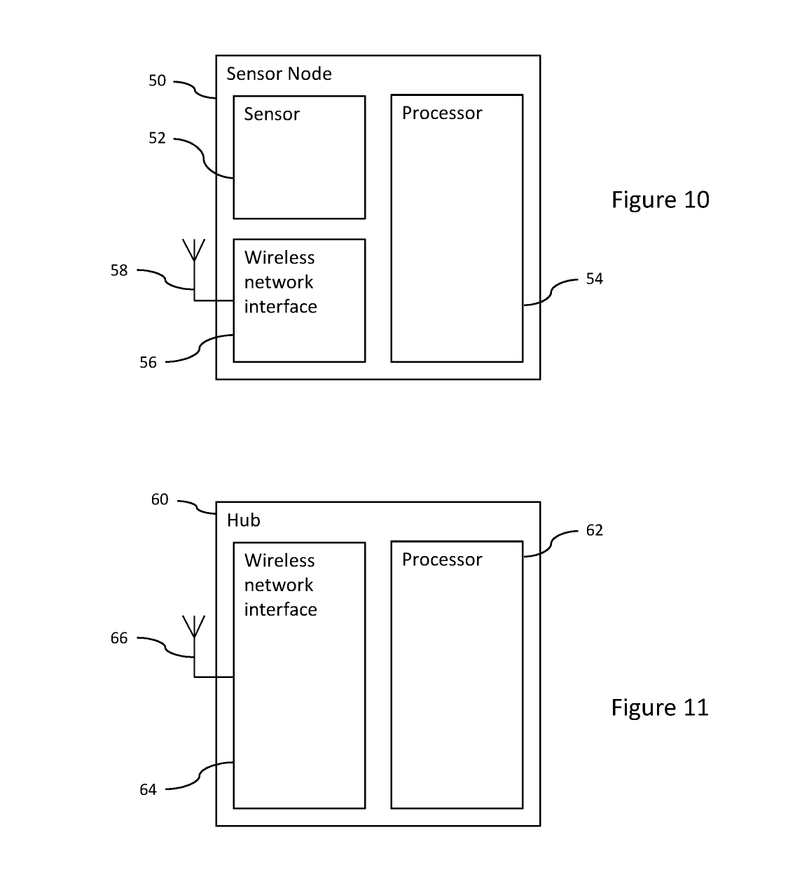

FIGS. 10 and 11 illustrate a sensor node (of which an on-body device is an example) and a hub, respectively.

FIGS. 1A and 1B illustrate a coexistence coordination mechanism which may minimise or eliminate such interference.

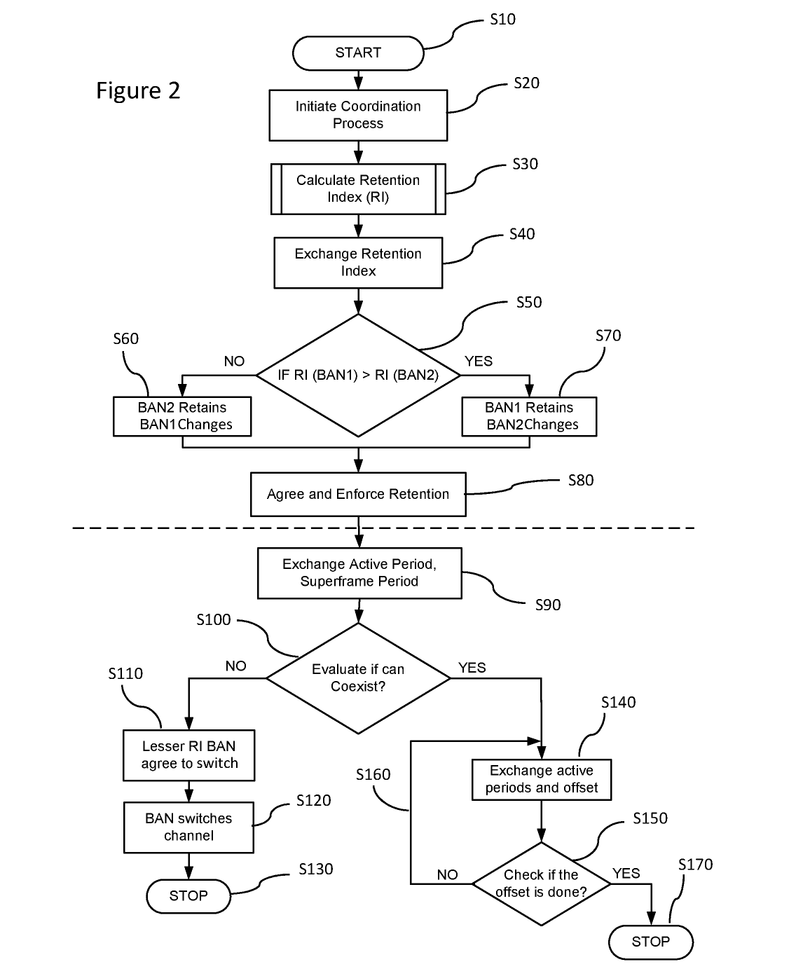

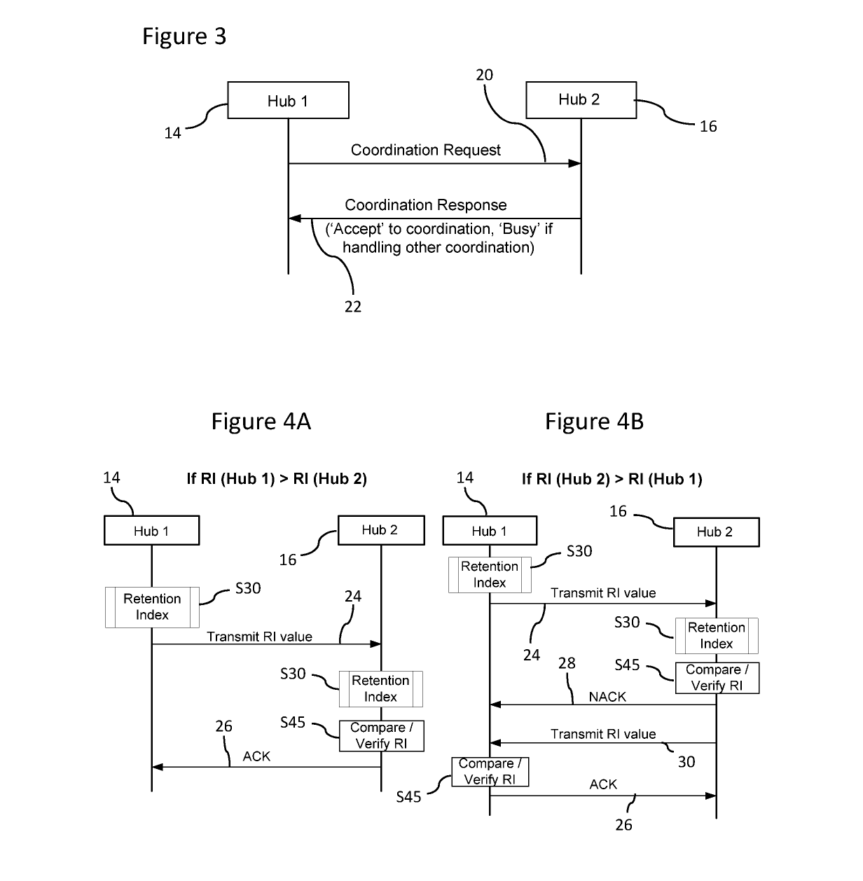

FIG. 2 illustrates a flow diagram of an embodiment. The flow diagram illustrates the coexistence coordination steps for two potentially-interfering WBANs 10, 12. The coexistence coordination mechanism of the present embodiment may be started S10 upon two WBANs using the same frequency channel coming within each other's transmission range. During operation, a hub may detect that an on-body device not associated with that WBAN has entered its transmission range. Upon detection of a potentially interfering on-body device or WBAN, a coordination process is initiated S20 between the WBANs (shown in more detail in FIG. 3).

Once the coordination process has been initiated S20, a retention index (RI) value is calculated S30 for each of the WBANs. RI values and the calculation thereof is discussed in more detail below. In the embodiment of FIG. 2, the RI value calculation step S30 follows the “initiate coordination process step” S20. In the present disclosure, “RI1” refers to the retention index of a first WBAN, “WBAN1”, and “R12” refers to the retention index of a second WBAN, “WBAN2”.

In the present embodiment only one of the WBANs will change its wireless communication behaviour. The other WBAN will retain its wireless communication behaviour. The RI values represent a “right to stay” and are used to determine which WBAN retains its wireless communication behaviour and which changes.

The two WBANs exchange RI values S40 (shown in more detail in FIGS. 4A and 4B). Each RI value is a number. In the present embodiment, a higher RI value means the WBAN has more right to maintain their current wireless communication behaviour due to the complex characteristics of the WBAN, although this is not necessarily the case in other embodiments.

After the RI values have been exchanged S40, a decision step S50 determines which WBAN has the highest RI value. This decision step S50 of FIG. 2 is implemented by determining “IF RI(WBAN1)>RI(WBAN2)”.

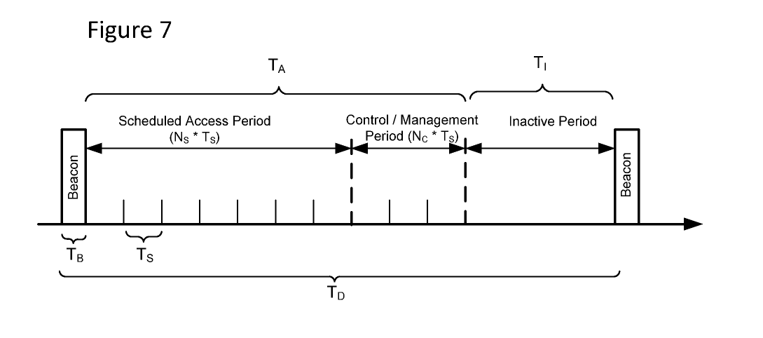

The decision step S50 determines which WBAN is to change its wireless communication behaviour. In the present embodiment, the wireless communication behaviour of each WBAN uses a superframe model. A superframe is a periodical frame of time of predetermined length. Each superframe is composed of slots of equal length and numbered from 0 to s, where s≦255. Each superframe comprises three parts: a beacon period of period T_{B}, an active period T_{A} and an inactive period T_{I}. This is illustrated in, and discussed further with reference to, FIG. 7. When a WBAN changes its wireless communication behaviour, a parameter of the superframe period may be changed; this may involve the active period being adapted e.g. shifted.

When RI(WBAN1)<RI(WBAN2), WBAN2 retains its wireless communication behaviour and WBAN1 changes its wireless communication behaviour S60. As such, the parameters of the superframe of WBAN2 remain unchanged. WBAN2 remains on the same channel. Thus, when WBAN1 has the lowest retention index, the wireless communication behaviour of WBAN1 is changed.

In the embodiment of FIG. 2, if RI(WBAN1)=RI(WBAN2), then the decision step S50 of “IF RI(WBAN1)>RI(WBAN2)” will give the same output as above S60, and so WBAN2 retains its wireless communication behaviour and WBAN1 changes its wireless communication behaviour S60. However, due to the personalised nature of WBANs and the definitions used to calculate the RI it is very unlikely that two WBANs will have the same RI. In some embodiments, if two interfering WBANs do have the same RI, an alternative definition may be used for RI calculation.

When RI(WBAN1)>RI(WBAN2), WBAN1 retains its wireless communication behaviour and WBAN2 changes its wireless communication behaviour S70. As such, the parameters of the superframe of WBAN1 remain unchanged. WBAN1 remains on the same channel or frequency. When WBAN2 has the lowest retention index, the wireless communication behaviour of WBAN2 is changed.

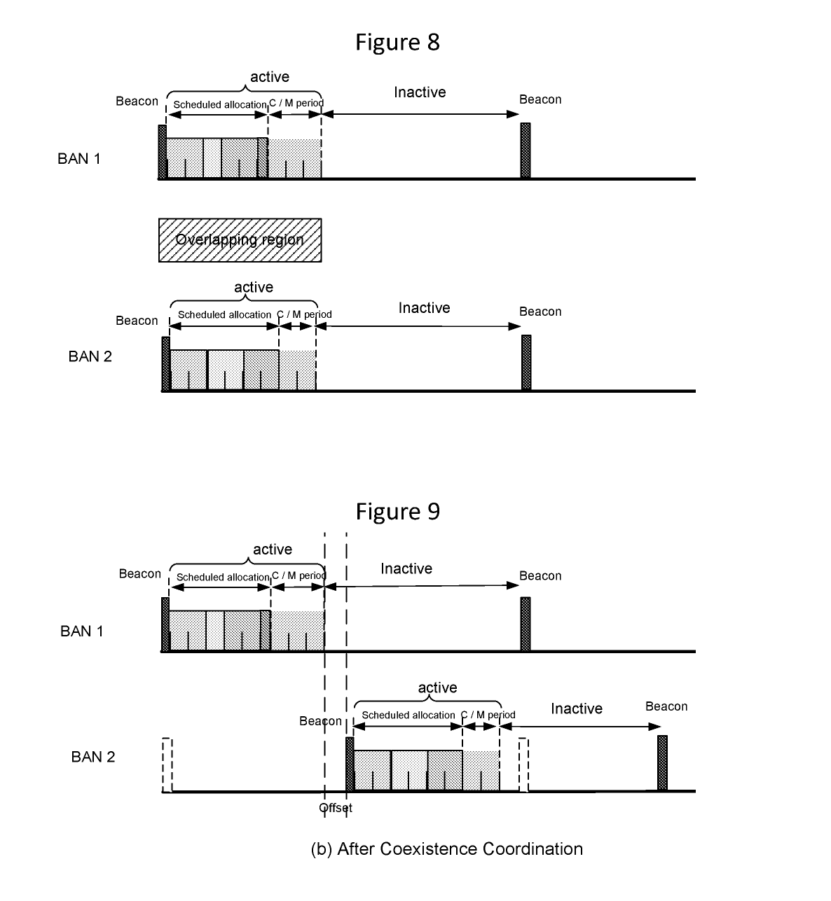

How the wireless communication behaviour is changed according to the present embodiment will be discussed further with respect to FIGS. 8 and 9.

Once it has been decided which WBAN is to retain its wireless communication behaviour and which is to change, there is a step to agree and enforce retention S80. This step is discussed further with reference to FIGS. 4A and 4B.

In the embodiment of FIG. 2, the process of evaluating whether the WBANs can coexist begins once the RI values have been compared and it has been decided which WBAN is to change its wireless communication behaviour. This process is started by the active period and superframe period (discussed further with reference to FIG. 7) of each WBAN being exchanged S90 and a decision step S100 being undertaken to decide whether the WBANs can coexist (discussed in more detail below).

If the WBANs are not suitable for coexistence, then the WBAN with the lower RI value (decided by a decision step S50 above) agrees S110 and switches frequency channel S120. The agreement step S110 comprises the relevant WBAN stopping the current transmission and starting to scan for alternative channels. This is then the end of the coexistence coordination S130.

If the WBANs are suitable for coexistence, information regarding the active and offset periods is exchanged and a parameter of the superframe of the WBAN with the lower RI value is changed S140. This may be done by shifting the active period. A decision step S150 with an iterative loop S160 is implemented to ensure this has been done before the coexistence coordination process ends S170. The two WBANs may both independently verify that the change has been made. This provides a feedback mechanism of verifying the coordination is performed as agreed. The two WBANs can now coexist.

Turning now to FIG. 3, an example of a coordination process according to step S20 of the embodiment of FIG. 2 is depicted. Hub1 (WBAN1's hub) initiates the coordination process by sending a coordination request 20 to hub2. Hub2 (WBAN2's hub) then sends a coordination response 22 either sending a “busy” reply if hub2 is handling other coordination processes, or accepting the coordination request if not. In the event of a “busy” response, hub1 may send a further request 20 in the following superframe or a periodical retransmission interval designated in the protocol.

FIGS. 4A and 4B illustrate examples of a message sequence for exchanging and comparing RI values, as well as agreeing and enforcing retention according to an embodiment.

FIG. 4A illustrates an example of a message sequence for when RI1 is larger than RI2. Here, hub1 14 calculates the retention index S30 for WBAN1 before transmitting 24 the RI1 value to hub2 16. Hub2 16 then calculates RI2 S30 and compares and/or verifies the RI values S45. When the compare and/or verify RI step S45 determines that RI1>RI2, an acknowledgement 26 is sent from Hub2 to hub1, confirming that RI1 is greater than RI2. This acknowledgement 26 enforces which WBAN is to change its wireless communication behaviour and which is to maintain its wireless communication behaviour.

FIG. 4B illustrates an example of a message sequence for when RI2 is larger than RI1. Here, hub1 14 calculates the retention index S30 for WBAN1 before transmitting 24 the RI1 value to hub2 16. Hub2 16 then calculates RI2 S30 and compares and/or verifies this with RI1 S45. Calculation of RI2 S30 may be initiated or completed before RI1 is transmitted. When the compare and/or verify RI step S45 determines that RI1<RI2, a non-acknowledgement 28 is sent from hub2 to hub1, as well as a transmission with RI2 30. Hub1 14 then compares and/or verifies the RI values S45 before sending an acknowledgement 26 to hub2 16, assuming RI1<RI2.

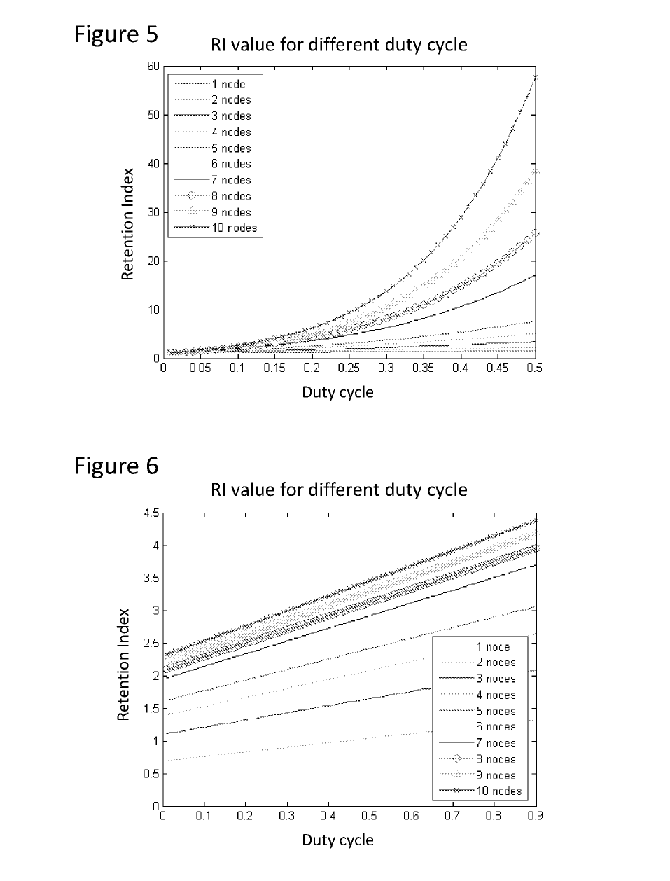

FIGS. 5 and 6 are two plots illustrating examples of RI value calculations wherein the RI value is dependent on the number of on-body devices and the duty cycle (proportion of a cycle in which a signal is active), wherein the duty cycle is represented by a normalised duty cycle value.

A normalised duty cycle may be used to fairly represent the behaviour of on-body devices that may have different access periodicity (e.g. 1-periodic access every superframe or m-periodic accesses every m superframes). A normalised duty cycle may provide the average proportion of activity signal, per superframe, over m superframes. The normalised duty cycle of the present embodiment is calculated by dividing the total amount of activity over m superframes, by m superframes. The normalised duty cycle allows on-body devices with different periodicity to be weighted accordingly in the coexistence mechanism. This is enabled through the use of the RI.

The characteristics taken into consideration for RI value calculation according to the present embodiment are the number of on-body devices of the WBAN and the application requirements thereof, as well as the duty cycle of the WBAN.

Examples of potential RI value definitions according to the present disclosure are as follows:

RI=D; (1)

RI=N; (2)

RI=(1+\hat{D})^{N}+k; or (3)

RI=(1+\hat{D}) log N+k; (4)

where N is the number of sensor nodes, i.e. on-body devices, of the respective WBAN, \hat{D} is a measure of the duty cycle of the respective WBAN and k denotes a constant proportional to performance drop. The performance drop is the packet drop due to collision.

Each of the above definitions can be used in different situations. Definition (1) can be used where the number of on-body devices on the compared WBANs is the same. Definition (2) can be used when the normalised duty cycle of the compared WBANs is the same. Definitions (3) and (4) provide alternative methods of calculating the RI value when the number of on-body devices on the compared WBANs is different and the normalised duty cycle of the compared WBANs is different.

FIG. 5 is a plot of the RI value for varying numbers of on-body devices and duty cycle according to definition 3. FIG. 6 is a plot of the RI value for varying numbers of on-body devices and duty cycle according to definition 4.

With reference to FIG. 2, once the coordination process has been initiated S20, each WBAN has calculated S30 and exchanged a RI value S40, and compared this value with a second WBAN S40 & S50, it is determined whether the two WBANs can coexist S90 & S100. This will now be discussed.

FIG. 7 illustrates an exemplar superframe period. The superframe comprises three parts: a beacon slot (or beacon period) of period T_{B}, an active period T_{A} and an inactive period T_{I}. Each superframe is bounded by beacons and hence the beacon interval (BI) represents the superframe period T_{D}. For tractable analysis BI=T_{D}=2^{BO} where BO is the beacon order. The WBAN picks the beacon order and hence the superframe period depending on the on-body devices attached. It is possible that the interfering WBANs have superframes of different lengths.

In TDMA-based scheduled access systems such as that of the present embodiment, the hub maintains synchronisation through beacon messages. This is in contrast to random access systems (such as contention access like CSMA/CA). A TDMA-based scheduled access approach is the most appropriate MAC solution to achieve a desired energy efficiency; it avoid many common causes of energy waste since the sensor nodes and coordinator are synchronised in time, the nodes only wake up when they have data to send. This scheduling is achieved by the hub sending periodic beacons and indicating specific times for each node to transmit data.

The WBAN hub or on-body devices will generally be transmitting and/or receiving during the active period T_{A}. During this active period there is a scheduled access period (during which data may be transmitted) and a control/management period (which is used for signalling purposes).

During the inactive period T_{I}, the WBAN is not active on the frequency channel.

The present embodiment changes the wireless communication behaviour, particularly by changing a parameter of the superframe, so as to arrange an operating period (comprising at least an active period) of a WBAN (e.g. one of an interfering pair of WBANs) to be during the inactive period of a further WBAN (e.g. of the interfering pair of WBANs). Thus, two interfering WBANs are arranged so that an operating period of the first WBAN coincides with the inactive period of a second WBAN and the operating period of the second WBAN coincides with the inactive period of the first WBAN. In the present embodiment, the respective beacon periods are also arranged so as to be during the inactive period of the further WBAN. Such an arrangement provides efficient coexistence.

In order to evaluate whether coexistence is possible, it is determined whether the superframe characteristics of the relevant WBANs are suitable, i.e. can the inactive period of each of the WBANs accommodate the necessary “operating period” of the other WBAN. The operating period of a first WBAN according to the present embodiment is defined as the period during which a second WBAN should not access the frequency channel to avoid possible interference with the first WBAN.

In order to ensure efficient coexistence, an operating period according to this embodiment comprises the beacon period T_{B}, the active period T_{A} and an offset period T_{offset}. The offset period is used to avoid any synchronisation. The offset period can be user-defined, fixed or negotiable between the WBANs. The offset period may be seen as a buffer or spacer, separating the beacon period of one WBAN from the active period of another.

In order for successful coexistence in the present embodiment, the operating period of a first WBAN must fit in an inactive period of the second WBAN, and the operation period of the second WBAN must fit in an inactive period of the first WBAN.

As such, the step of evaluating if the WBANs can coexist S100 for the present embodiment comprises checking that:

T_{I}(WBAN1)>T_{A}(WBAN2)+T_{B}+T_{offset}

and

T_{I}(WBAN2)>T_{A}(WBAN1)+T_{B}+T_{offset}

wherein the operating period may be T_{A}(WBANₓ)+T_{B}+T_{offset}.

In other embodiments the above inequalities might be replaced with “equal or greater than” signs.

FIG. 2 illustrates the steps taken according to the present embodiment depending on the outcome of the above determination. If one of the above inequalities is not true, the WBANs are not be suitable for coexistence as the operating period of one WBAN is too long for the inactive period of the other WBAN. This may be the case when the superframes of the two WBANs are of different lengths, or simply because the duty cycle of one or both WBANs is too high. In such a case, the WBAN with the smaller RI value will switch channels S110 and S120. Thus its wireless communication behaviour is changed. As it is already clear which WBAN is to retain its wireless communication behaviour and which is to change a parameter of its superframe, or switch channels due to the determination and comparing of the RI values, instructions and information are more easily, effectively and unambiguously communicated in embodiments according to the present disclosure.

If both of the above inequalities are true then the WBANs may be suitable for coexistence. The next step is the WBAN that retains its wireless communication behaviour (that with the higher RI value) providing unambiguously clear information on its active period, offset period and the start and end of its inactive period S140. As it is already clear which WBAN is to retain its wireless communication behaviour and which is to change its wireless communication behaviour or switch channels due to the determination and comparing of the RI values, instructions and information can be more easily, effectively and unambiguously communicated in embodiments according to the present disclosure. The WBAN that is to change its wireless communication behaviour changes a parameter of its superframe (e.g. shifts its active period) and then provides information on its new superframe and active period to the WBAN that retained its wireless communication behaviour for confirmation S140. The WBAN that retains its wireless communication behaviour verifies this and confirms whether the offset has been done S150. This step is done iteratively S160 until the coexistence is successfully completed S170.

FIGS. 8 and 9 show wireless communication behaviour adaption according to an embodiment. FIG. 8 illustrates two WBANs, WBAN1 and WBAN2, operating on the same frequency channel and interfering during the overlapping region. FIG. 9 illustrates the same WBANs after a coexistence processes according to the present embodiment has been completed. It can be seen that the superframe of WBAN2 has been shifted. As such, the active period of WBAN2 coincides with the inactive period of WBAN1.

FIG. 10 illustrates a sensor node 50 or a part of a sensor node. The sensor node 50 may be an on-body device. The sensor node of FIG. 10 comprises a processor 54 for coordinating communication with a hub, a sensor 52 for measuring a specific characteristic of a wearer or the environment e.g. temperature, and a wireless network interface 56 for communicating with a hub. The wireless network interface 56 comprises an antenna 58.

FIG. 11 illustrates a hub 60 or a part of a hub. The hub 60 of FIG. 11 comprises a processor 62 for coordinating communication with a sensor node and a wireless network interface 64 for communicating with a sensor node. The wireless network interface 64 may comprise an antenna 66. The processor 62 is operable to compare the retention index of a second WBAN with a retention index of the hub's WBAN and change the wireless communication behaviour of the hub's WBAN if the retention index of the hub's WBAN is lower than the retention index of the second WBAN. The antenna 66 is operable to receive a retention index of a second WBAN operating on the same frequency channel as the hub 60.

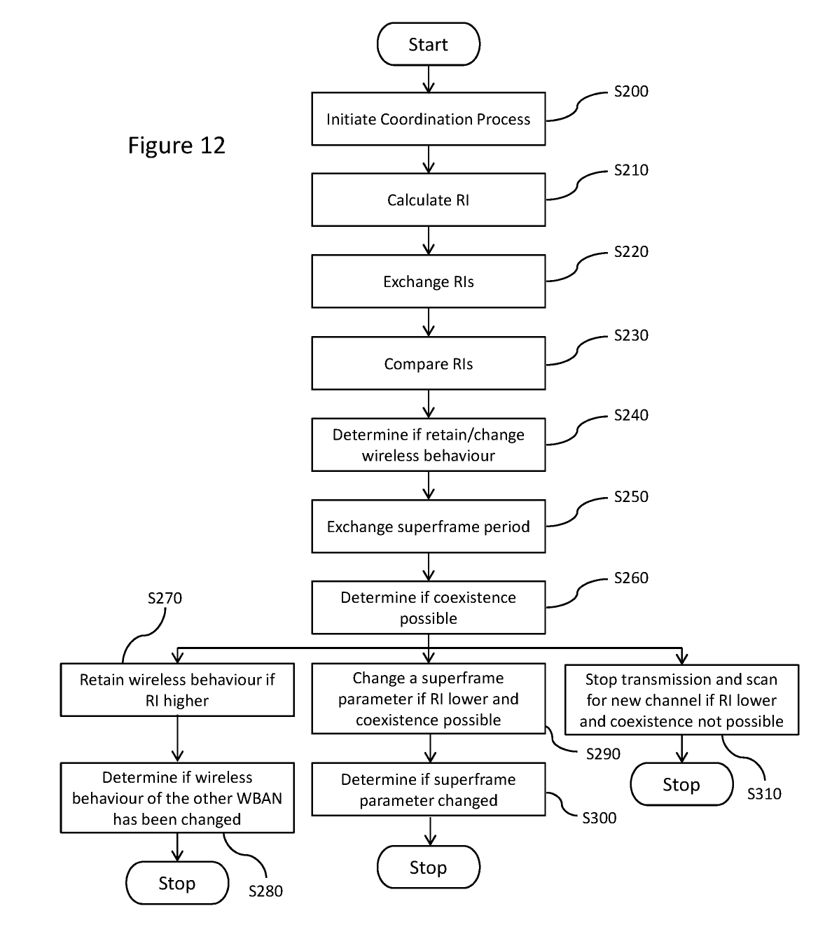

FIG. 12 illustrates a flow diagram employed by hub of a WBAN according to an embodiment. The flow diagram of FIG. 12 illustrates a process undertaken by a first WBAN when interfering with a second WBAN.

The coordination process is initiated S200, as described in relation to FIG. 3. The hub of the first WBAN then calculates the retention index for the first WBAN S210, exchanges this RI value with that of the second WBAN S220 and compares the two RIs S230. This may involve the first WBAN sending its RI value to the second WBAN and receiving the second WBAN's RI value, and will allow the first WBAN to determine if it should retain or change its wireless communication behaviour S240. This process is discussed above. The superframe periods are then exchanged S250, with the first WBAN sending information regarding its superframe period and active period to the second WBAN, and receiving the equivalent information from the second WBAN. This then allows the first WBAN to determine if coexistence is possible S260; this determination may be done as described above.

If the RI value of the first WBAN is higher than that of the second WBAN, the first WBAN maintains its wireless communication behaviour S270. This step is followed by the first WBAN determining if the wireless behaviour of the second WBAN has been changed S280. This step provides a feedback mechanism of verifying that the coordination has been performed as agreed.

If the RI value of the first WBAN is lower than that of the second WBAN and coexistence is possible, the first WBAN changes a superframe parameter S290, as described above. This step is followed by the first WBAN determining if its wireless behaviour has been successfully changed S300. This may involve the first WBAN sending the second WBAN confirmation that the superframe parameter has been changed, or sending the second WBAN information regarding its new superframe parameters. This step provides a feedback mechanism of verifying that the coordination has been performed as agreed.

If the RI value of the first WBAN is lower than that of the second WBAN and coexistence is not possible, the first WBAN stops transmitting and scans for a new frequency channel S310.

WBANs compatible with the present disclosure may comprise any number of sensor nodes, e.g. on-body devices. WBANs suitable for use with the present methods may comprise one, two, three, four, five or more than five sensor nodes. WBANs may comprise more than 10, 15 or 20 sensor nodes.

Characteristics which may be taken into consideration for RI value calculation may be the number of sensor nodes associated with the WBAN, the application requirements thereof and/or the duty cycle of the WBAN. For example, a WBAN with 12 different on-body devices with a normalised duty cycle of 0.7 superframe, and a WBAN with a single on-body device with a normalised duty cycle of 0.1 superframe may not be considered “equal”. Hence the WBANs may not be considered to have an equal right to maintain their current wireless communication behaviour when considering how the wireless communication behaviour should be changed for coexistence.

In other embodiments according to the present disclosure, the RI may be calculated to reflect different characteristics of WBANs. For example, the RI may be calculated to be dependent on the superframe length, or to be dependent only on sensor nodes of a specific type.

The RI value may be a user-definable index, the definition or calculation of which can be tailored to quantify the importance of, or the “right-to-stay” of WBANs. The definition used to obtain an RI value may vary depending on the types of WBAN, on-body devices or sensor nodes used, as well as the location in which the WBANs are located.

A special case may exist for priority or emergency sensor nodes. The above-described definitions generally assume that all the sensor nodes have an equal priority. It may be, however, that certain sensor nodes should have a higher priority, or importance, than others. For example, perhaps certain biochemical sensors are felt to be more critical to a patient's well-being than a temperature sensor, in which case a weighting may be introduced to emphasize the importance of the biochemical sensor. A weighting can be introduced to help ensure WBANs with high priority sensor nodes maintain their wireless communication behaviour. The weighting may be implemented by multiplying each type of node by a fraction between 0 and 1, with higher values indicating higher priorities. The RI definition may be set so that certain weightings are incorporated therein, or that only certain sensor nodes are considered.

It may also be the case in some embodiments that a specific WBAN may require more right to maintain its wireless communication behaviour than would normally be afforded it due to the characteristics of the WBAN alone. For example, a patient may have a certain condition that increases the risk posed to their health, meaning that although they may have a relatively “low-RI” type WBAN, the severity of their condition means it should have more right to maintain its wireless communication behaviour. Such a weighting may be incorporated into the RI value.

The above weightings may be factored into the calculation of the RI value, or may be implemented as another “level” wherein a low RI value is calculated, but a weighting is subsequently applied to factor in any circumstances as discussed above.

The RI calculation or definition may be determined by a user. A user may be able to redefine, change or alter the RI definition during use.

The RI value calculation step may be a pre-defined process or a sub-process of the present method. The RI value may be calculated at any point preceding the RI value exchange and compare steps. The RI value may be calculated during the RI value exchange and compare steps. The RI value may be calculated before the coexistence coordination method begins. The RI value may be pre-programmed as a feature of the WBAN, thus the method of FIG. 2 may not include a step of calculating the RI value, it may simply comprise an exchanging RI value step, the RI value being pre-known.

It is to be understood that throughout the present disclosure WBAN1 and WBAN2 are generic names given to two WBANs and that in each process step or sub-process step, WBAN1 and WBAN2 can be used largely interchangeably to refer to either WBAN. As such, where a specific hub or WBAN is said to initiate a process step, it is to be understood that either or any WBAN—regardless of whether it has previously been labelled WBAN1, WBAN2 or otherwise—can initiate any process step.

Although the above description relates to WBANs, it is to be understood that the above methods may apply equally to analogous wireless network systems, as would be appreciated by a skilled reader.

The specific embodiments are presented schematically. The reader will appreciate that the detailed implementation of each embodiment can be achieved in a number of ways. For instance, a dedicated hardware implementation could be designed and built. On the other hand, a processor could be configured with a computer program, such as delivered either by way of a storage medium (e.g. a magnetic, optical or solid state memory based device) or by way of a computer receivable signal (e.g. a download of a full program or a “patch” update to an existing program) to implement the method described above in relation to the embodiments. Besides these two positions, a multi-function hardware device, such as a DSP, a FPGA or the like, could be configured by configuration instructions.

While certain embodiments have been described, these embodiments have been presented by way of example only, and are not intended to limit the scope of the inventions. Indeed the novel methods and apparatuses described herein may be embodied in a variety of other forms; furthermore, various omissions, substitutions and changes in the form of methods and apparatuses described herein may be made without departing from the spirit of the inventions. The accompanying claims and their equivalents are intended to cover such forms or modifications as would fall within the scope and spirit of the inventions.

1. A method in a hub of a first wireless body area network (WBAN), the first WBAN comprising the hub and at least one sensor node, the hub being configured to wirelessly communicate with the at least one sensor node on a first frequency channel, the method comprising:
receiving a retention index of a second WBAN operating on the first frequency channel, wherein a retention index is a measure of the operational characteristics of the respective WBAN;
comparing the retention index of the second WBAN with a retention index of the first WBAN; and
changing the wireless communication behaviour of the first WBAN if the retention index of the first WBAN is lower than the retention index of the second WBAN.

2. A method according to claim 1, wherein the retention index is a function of at least one of N and \hat{D}, wherein N is the number of sensor nodes of the respective WBAN and \hat{D} is a measure of the duty cycle of the respective WBAN.

3. A method according to claim 2, wherein the retention index is according to at least one of the following definitions:
RI=\hat{D}; (1)
RI=N; (2)
RI=(1+\hat{D})^{N}+k; or (3)
RI=(1+\hat{D})log N+k; (4)
wherein k denotes a constant proportional to performance drop.

4. A method according to claim 1, further comprising:
calculating the retention index of the first WBAN.

5. A method according to claim 1, further comprising:
sending a coordination request to a hub of the second WBAN; and
receiving a coordination response from the hub of the second WBAN.

6. A method according to claim 1, further comprising:
determining whether the first WBAN and second WBAN are suitable for coexistence on the first frequency channel.

7. A method according to claim 6, wherein the first and second WBAN wirelessly communicate according to a periodic superframe structure and determining whether the first and second WBAN are suitable for coexistence comprises:
assessing whether an inactive period of a superframe of the first WBAN is at least as long as an operating period of a superframe of the second WBAN; and
assessing whether an inactive period of the superframe of the second WBAN is at least as long as an operating period of the superframe of the first WBAN;
wherein the operating period comprises an active period of the respective WBAN.

8. A method according to claim 7, wherein the first and second WBAN wirelessly communicate according to a periodic superframe structure and, when the first and second WBAN are suitable for coexistence, changing the wireless communication behaviour of the first WBAN comprises changing a parameter of a superframe of the first WBAN.

9. A method according to claim 6, wherein when the first and second WBAN are not suitable for coexistence, changing the wireless communication behaviour of the first WBAN comprises:
switching to a second frequency channel.

10. A method according to claim 8, wherein changing a parameter of the superframe of the first WBAN comprises:
the active period of the superframe of the first WBAN being adapted so the operating period of the superframe of the first WBAN coincides with the inactive period of the superframe of the second WBAN and the operating period of the superframe of the second WBAN coincides with the inactive period of the superframe of the first WBAN.

11. A method according to claim 1, further comprising: verifying that the wireless communication behaviour has been successfully changed.

12. A hub for a wireless body area network WBAN, the hub operable to wirelessly communicate with at least one sensor node over a first frequency channel, and comprising:
an antenna operable to receive a retention index of a further WBAN operating on the first frequency channel, wherein a retention index is a measure of the operational characteristics of the respective WBAN; and
a processor operable to compare the retention index of the further WBAN with a retention index of the WBAN and change the wireless communication behaviour of the WBAN if the retention index of the WBAN is lower than the retention index of the further WBAN.

13. A hub according to claim 12, wherein the retention index is a function of at least one of N and \hat{D}, wherein N is the number of sensor nodes of the respective WBAN and \hat{D} is a measure of the duty cycle of the respective WBAN.

14. A hub according to claim 12, wherein the retention index is according to at least one of the following definitions:
RI=\hat{D}; (1)
RI=N; (2)
RI=(1+\hat{D})^{N}+k; or (3)
RI=(1+\hat{D})log N+k; (4)
wherein k denotes a constant proportional to performance drop.

15. A hub according to claim 12, wherein the processor is operable to calculate the retention index of the WBAN.

16. A hub according to claim 12, wherein the WBAN and further WBAN wirelessly communicate according to a periodic superframe structure and the processor is operable to determine whether the WBAN and further WBAN are suitable for coexistence, by:
assessing whether an inactive period of the superframe of the WBAN is at least as long as an operating period of a superframe of the further WBAN; and
assessing whether an inactive period of the superframe of the further WBAN is at least as long as an operating period of the superframe of the WBAN;
wherein the operating period comprises an active period of the respective wireless network.

17. A hub according to claim 16 wherein when the WBAN and further WBAN are suitable for coexistence, to change the wireless communication behaviour of the WBAN the processor is operable to:
change a parameter of the superframe of the WBAN.

18. A hub according to claim 17 wherein, to change a parameter of the superframe of the WBAN, the processor is operable to:
adapt the active period of the superframe of the WBAN so that the operating period of the superframe of the WBAN coincides with the inactive period of the superframe of the further WBAN and the operating period of the superframe of the further WBAN coincides with the inactive period of the superframe of the WBAN.

19. A hub according to claim 16 wherein, when the WBAN and further WBAN are not suitable for coexistence, to change the wireless communication behaviour of the WBAN the processor is operable to:
switch to a second frequency channel.

20. A computer readable carrier medium carrying computer executable instructions which, when executed on a processor, cause the processor to carry out a method according to claim 1.
